(19) United States
(12) Patent Application Publication
(10) Pub. No.: US 2022/0092564 A1
(43) Pub. Date: Mar. 24, 2022

(54) RESOURCE CONFIGURATION METHODS, APPARATUSES, AND SYSTEMS

(71) Applicant: ALIPAY (HANGZHOU) INFORMATION TECHNOLOGY CO., LTD., Hangzhou (CN)

(72) Inventors: Jiongguang Guo, Hangzhou (CN); Tingwen Li, Hangzhou (CN); Hui Li, Hangzhou (CN); Kaihua Lu, Hangzhou (CN); Lingnan Shen, Hangzhou (CN)

(73) Assignee: ALIPAY (HANGZHOU) INFORMATION TECHNOLOGY CO., LTD., Hangzhou (CN)

(21) Appl. No.: 17/357,731

(22) Filed: Jun. 24, 2021

(30) Foreign Application Priority Data
Sep. 23, 2020 (CN) 202011009324.3

(51) Int. Cl. G06Q 20/10; G06Q 20/06; G06Q 20/40

(52) U.S. Cl. CPC G06Q 20/102; G06Q 20/4014; G06Q 20/0655

(57) ABSTRACT

Disclosed herein are methods, systems, and media for automatically transferring resources in response to detecting a transfer-out. One of the methods comprises automatically generating a first request for acquiring a resource for a first resource space of a target application in response to detecting that a transfer-out from the first resource space has occurred, wherein the first resource space stores resources to be used by the target application; sending the first request to a managing device of the target application; receiving an allocation instruction from the managing device, wherein the allocation instruction is based on the first request, and wherein the allocation instruction comprises a first target resource; and transferring the first target resource to the first resource space of the target application according to the allocation instruction.

### CROSS-REFERENCE TO RELATED APPLICATIONS

This application claims priority to Chinese Patent Application No. 202011009324.3, filed on Sep. 23, 2020, which is hereby incorporated by reference in its entirety.

### TECHNICAL FIELD

The present specification relates to the field of computer technologies, and in particular, to resource configuration methods, apparatuses, and systems.

### BACKGROUND

With the rapid development of computer technologies, network has become an important part of people's lives. Particularly, electronic payment provides convenience for people's daily life. In the existing technology, a user can apply for an electronic account, and deposit a specific amount of funds in the electronic account in advance for subsequent daily expenses. During subsequent spending, the user can directly deduct a corresponding spending amount from the electronic account and pay the amount to a payee. However, in the previous process, recharge and consumption are two completely independent processes. Users need to pay attention to the remaining funds in their electronic accounts regularly and recharge in time. As a result, it is very likely that the balances of funds in the electronic accounts are insufficient and the users cannot consume, causing inconvenience to the users. Therefore, it is necessary to provide a simpler and more convenient resource configuration method for completing funds recharge.

### SUMMARY

In view of the previous description, embodiments of the present specification provide resource configuration methods. The present specification further relates to resource configuration apparatuses, resource configuration systems, computing devices, and computer-readable storage media, so as to solve technical deficiencies in the existing technology.

According to a first aspect of some embodiments of the present specification, a resource configuration method is provided, including the following: when it is detected that resource transfer-out occurs in a first resource space of a target application, generating a resource acquisition request for the first resource space; sending the resource acquisition request to a resource managing party of the target application, and receiving a resource allocation instruction returned by the resource managing party in response to the resource acquisition request, where the resource allocation instruction includes a to-be-allocated first target resource; and transferring the first target resource to the first resource space of the target application according to the resource allocation instruction.

Optionally, the generating a resource acquisition request for the first resource space includes the following: generating a resource acquisition verification factor for obtaining a resource, and generating second verification information; generating third verification information based on a result of the resource transfer-out and the resource acquisition verification factor; and generating the resource acquisition request based on the second verification information and the third verification information.

Optionally, the resource allocation instruction includes fourth verification information, and the transferring the first target resource to the first resource space of the target application according to the resource allocation instruction includes the following: verifying the resource allocation instruction based on the fourth verification information included in the resource allocation instruction, and when the verification succeeds, performing the operation step of transferring the first target resource to the first resource space of the target application according to the resource allocation instruction.

Optionally, before the generating a resource acquisition request for the first resource space, the method further includes the following: receiving a resource transfer-out instruction sent by a resource receiver, where the resource transfer-out instruction includes a second target resource to be transferred out; transferring the second target resource in the first resource space to a second resource space according to the resource transfer-out instruction, where the second resource space is a resource space corresponding to the resource receiver; and when the transfer-out of the second target resource is completed, determining that it is detected that the resource transfer-out occurs in the first resource space.

Optionally, the resource transfer-out instruction further includes first verification information, and after the receiving a resource transfer-out instruction sent by a resource receiver, and before the transferring the second target resource in the first resource space to a second resource space according to the resource transfer-out instruction, the method further includes the following: verifying the resource transfer-out instruction based on the first verification information, and when the verification succeeds, performing the operation step of transferring the second target resource in the first resource space to a second resource space according to the resource transfer-out instruction.

Optionally, after the receiving a resource transfer-out instruction sent by a resource receiver, and before the transferring the second target resource in the first resource space to a second resource space according to the resource transfer-out instruction, the method further includes the following: determining whether a resource in the first resource space is greater than or equal to the second target resource, and if yes, performing the operation step of transferring the second target resource in the first resource space to a second resource space according to the resource transfer-out instruction.

Optionally, after the transferring the second target resource in the first resource space to a second resource space according to the resource transfer-out instruction, the method further includes the following: when the transfer-out of the second target resource is completed, determining whether a remaining resource in the first resource space is greater than a predetermined threshold, and if no, generating the resource acquisition request for the first resource space.

Optionally, after the transferring the second target resource in the first resource space to a second resource space, the method further includes the following: generating a first resource transfer response message that includes fifth verification information; and sending the first resource transfer response message to the resource managing party.

Optionally, after the transferring the first target resource to the first resource space of the target application according to the resource allocation instruction, the method further includes the following: generating a second resource transfer response message that includes sixth verification information; and sending the second resource transfer response message to the resource managing party.

Optionally, after the generating third verification information based on a result of the resource transfer-out and the resource acquisition verification factor, the method further includes the following: generating a third resource transfer response message based on the third verification information; and sending the third resource transfer response message to the resource receiver.

According to a second aspect of some embodiments of the present specification, a resource configuration apparatus is provided, including the following: a generating module, configured to: when it is detected that resource transfer-out occurs in a first resource space of a target application, generate a resource acquisition request for the first resource space; a first receiving module, configured to send the resource acquisition request to a resource managing party of the target application, and receive a resource allocation instruction returned by the resource managing party in response to the resource acquisition request, where the resource allocation instruction includes a to-be-allocated first target resource; and a transfer module, configured to transfer the first target resource to the first resource space of the target application according to the resource allocation instruction.

According to a third aspect of some embodiments of the present specification, a resource configuration system is provided, where the system includes a first terminal device, a second terminal device configured with a target application, and a server for a resource management service of the target application; a communication connection is established between the first terminal device and the second terminal device, and a communication connection is established between the second terminal device and the server; the first terminal device is configured to generate a resource transfer-out instruction, and send the resource transfer-out instruction to the second terminal device, where the resource transfer-out instruction includes a second target resource to be transferred out; the second terminal device is configured to: receive the resource transfer-out instruction, and transfer a second target resource in a first resource space to a second resource space according to the resource transfer-out instruction, where the first resource space is a resource space corresponding to the target application, and the second resource space is a resource space corresponding to the first terminal device; generate a resource acquisition request for the first resource space based on a result of the resource transfer-out, and send the resource acquisition request to the server; receive a resource allocation instruction returned by the server, where the resource allocation instruction includes a to-be-allocated first target resource; and transfer the first target resource to the first resource space of the target application according to the resource allocation instruction; and the server is configured to receive the resource acquisition request, generate the resource allocation instruction that includes the first target resource based on the resource acquisition request, and send the resource allocation instruction to the second terminal device.

Optionally, the resource transfer-out instruction further includes first verification information, and the second terminal device is further configured to: when receiving the resource transfer-out instruction, verify the resource transfer-out instruction based on the first verification information, and when the verification succeeds, perform the operation step of transferring a second target resource in a first resource space to a second resource space according to the resource transfer-out instruction.

Optionally, the second terminal device is further configured to: generate a resource acquisition verification factor for obtaining a resource, and generate second verification information; and generate third verification information based on a result of the resource transfer-out and the resource acquisition verification factor, and add the second verification information and the third verification information to the resource acquisition request.

Optionally, the server is further configured to: verify the resource acquisition request based on the third verification information included in the resource acquisition request, and when the verification succeeds, generate fourth verification information based on the second verification information and the third verification information; and add the fourth verification information to the resource allocation instruction.

Optionally, the second terminal device is further configured to: verify the resource allocation instruction based on the fourth verification information included in the resource allocation instruction, and when the verification succeeds, perform the operation step of transferring the first target resource to the first resource space of the target application according to the resource allocation instruction.

Optionally, the second terminal device is further configured to: when receiving the resource transfer-out instruction, determine whether a resource in the first resource space is greater than or equal to the second target resource, and if yes, perform the operation step of transferring a second target resource in a first resource space to a second resource space.

Optionally, the second terminal device is further configured to: when the transfer-out of the second target resource is completed, determine whether a remaining resource in the first resource space is greater than a predetermined threshold, and if no, generate the resource acquisition request for the first resource space.

Optionally, the second terminal device is further configured to: when the second target resource in the first resource space is transferred to the second resource space, generate a first resource transfer response message that includes fifth verification information; and send the first resource transfer response message to the server; and correspondingly, the server is further configured to: verify the first resource transfer response message based on the fifth verification information included in the received first resource transfer response message, and when the verification succeeds, update a resource in the first resource space.

Optionally, the second terminal device is further configured to: when the first target resource is transferred to the first resource space of the target application, generate a second resource transfer response message that includes sixth verification information; and send the second resource transfer response message to the server; and correspondingly, the server is further configured to: verify the second resource transfer response message based on the sixth verification information included in the received second resource transfer response message, and when the verification succeeds, update a resource in the first resource space.

Optionally, the second terminal device is further configured to: generate a third resource transfer response message based on the third verification information; and send the third resource transfer response message to the first terminal device; and correspondingly, the first terminal device is further configured to: generate and display a result of the resource transfer-out based on the received third resource transfer response message.

Optionally, the first terminal device is further configured to: send an application selection instruction that includes a device identifier of the first terminal device to the second terminal device, and receive an application response message returned by the second terminal device; and when receiving the application response message, generate the resource transfer-out instruction; and correspondingly, the second terminal device is further configured to: determine a corresponding target application based on the device identifier included in the received application selection instruction, and send the application selection instruction to the target application; and obtain an application response message returned by the target application, and send the application response message to the first terminal device.

According to a fourth aspect of some embodiments of the present specification, a resource configuration method is provided, including the following: generating, by a first terminal device, a resource transfer-out instruction, and sending the resource transfer-out instruction to a second terminal device, where the resource transfer-out instruction includes a second target resource to be transferred out; receiving, by the second terminal device, the resource transfer-out instruction, and transferring a second target resource in a first resource space to a second resource space according to the resource transfer-out instruction, where the first resource space is a resource space corresponding to the target application, and the second resource space is a resource space corresponding to the first terminal device; and generating a resource acquisition request for the first resource space based on a result of the resource transfer-out, and sending the resource acquisition request to the server; receiving, by the server, the resource acquisition request, generating the resource allocation instruction that includes the to-be-allocated first target resource based on the resource acquisition request, and sending the resource allocation instruction to the second terminal device; and receiving, by the second terminal device, the resource allocation instruction returned by the server, and transferring the first target resource to the first resource space of the target application according to the resource allocation instruction.

According to a fifth aspect of some embodiments of the present specification, a computing device is provided, including the following: a memory and a processor, where the memory is configured to store a computer-executable instruction, and the processor is configured to execute the computer-executable instruction to implement the following method: when it is detected that resource transfer-out occurs in a first resource space of a target application, generating a resource acquisition request for the first resource space; sending the resource acquisition request to a resource managing party of the target application, and receiving a resource allocation instruction returned by the resource managing party in response to the resource acquisition request, where the resource allocation instruction includes a to-be-allocated first target resource; and transferring the first target resource to the first resource space of the target application according to the resource allocation instruction.

According to a sixth aspect of some embodiments of the present specification, a computer-readable storage medium is provided, where the computer-readable storage medium stores a computer-executable instruction, and the instruction is executed by a processor to implement the steps of the resource configuration method according to the first aspect.

The resource configuration method provided in the present specification includes the following: when it is detected that resource transfer-out occurs in a first resource space of a target application, generating a resource acquisition request for the first resource space; sending the resource acquisition request to a resource managing party of the target application, and receiving a resource allocation instruction returned by the resource managing party in response to the resource acquisition request, where the resource allocation instruction includes a to-be-allocated first target resource; and transferring the first target resource to the first resource space of the target application according to the resource allocation instruction. In this case, because the resource configured for the first resource space is used for subsequent resource transfer-out, that is, the behavior of obtaining the resource and the behavior of resource transfer-out are associated with each other, if resource transfer-out occurs in the first resource space, the resource acquisition operation can be directly and automatically initiated based on the result of the resource transfer-out, to request to obtain the resource from the resource managing party, and the user does not need to initiate the resource acquisition operation separately This ensures that there is always a sufficient resource in the first resource space for resource transfer-out, avoids consumption failure due to insufficient balance, facilitates the user's operation, and improves the user experience.

### BRIEF DESCRIPTION OF DRAWINGS

FIG. 1 is a flowchart illustrating a resource configuration method, according to some embodiments of the present specification;

FIG. 2 is a processing flowchart illustrating a resource configuration method applied to a terminal device, according to some embodiments of the present specification;

FIG. 3 is an interaction diagram illustrating a resource configuration method applied to a public transportation scenario, according to some embodiments of the present specification;

FIG. 4 is a schematic structural diagram illustrating a resource configuration apparatus, according to some embodiments of the present specification;

FIG. 5 is a schematic structural diagram illustrating a resource configuration system, according to some embodiments of the present specification; and

FIG. 6 is a structural block diagram illustrating a computing device, according to some embodiments of the present specification.

### DESCRIPTION OF EMBODIMENTS

Many specific details are described in the following description to facilitate full understanding of the present specification. However, the present specification can be implemented in many different ways from those described herein, and a person skilled in the art can make similar promotion without departing from the content of the present specification, so the present specification is not limited to the specific implementations disclosed below.

The terms used in one or more embodiments of the present specification are for the purpose of describing specific embodiments only, and are not intended to limit one or more embodiments of the present specification. The terms “a” and “the” of singular forms used in one or more embodiments of the present specification and the appended claims are also intended to include plural forms, unless otherwise specified in the context clearly. It should be further understood that the term “and/or” used in one or more embodiments of the present specification refers to and includes any or all possible combinations of one or more associated listed items.

It should be understood that although terms “first,” “second,” etc. can be used in one or more embodiments of the present specification to describe various types of information, the information is not limited to these terms. These terms are used merely to differentiate information of the same type. For example, the first can also be referred to as the second without departing from the scope of one or more embodiments of the present specification, and similarly, the second can be referred to as the first. Depending on the context, the word “if” used herein can be interpreted as “when” or “while” or “in response to determining.”

First, terms used in one or more embodiments of the present specification are explained.

Radio frequency identification (RFID): The RFID technology is a type of automatic identification technology. Its principle is to perform non-contact data communication between a reader and a tag to achieve the purpose of identifying a target. Specifically, non-contact two-way data communication can be performed through radio frequency, and a recording medium (an electronic tag or a radio frequency card) can be read and written through radio frequency, so as to achieve the purpose of target identification and data exchange. RFID can implement non-contact two-way communication by using a technology of non-contact fast information exchange and storage through radio waves, by using a technology of combining wireless communication with data access, and by connecting to a database system, so as to achieve the purpose of identification. RFID is used for data exchange, connection of a very complex system, and realization of reading, writing, and communication of electronic tags in the identification system through electromagnetic waves. RFID has a wide range of applications. Typical applications include animal chips, car chip anti-theft devices, access control, parking lot control, production line automation, material management, etc.

Near field communication (NFC): NFC is an emerging technology. Devices using the NFC technology (such as mobile phones) can exchange data when they are close to each other. NFC is derived from integration and evolution of the non-contact RFID and interconnection technologies. Inductive card readers, inductive cards, and point-to-point communication functions are integrated on a single chip, and mobile terminals are used to implement mobile payment, electronic ticketing, access control, mobile identity recognition, anti-counterfeiting, and other applications.

Mobile terminal: also referred to as a mobile communications terminal, which refers to a computer device that can be used during movement, and in a broad sense, includes a mobile phone, a notebook, a tablet computer, a POS terminal, or even a vehicle-mounted computer. However, in most cases, the mobile terminal refers to a mobile phone, or a smartphone and a tablet computer having multiple application functions. With the development of networks and technologies in the direction of becoming more adapted to broadband, the mobile communications industry will move towards a true mobile information era. In addition, with the rapid development of integrated circuit technologies, mobile terminals have already possessed powerful processing capabilities, and mobile terminals are evolving from simple conversation tools to comprehensive information processing platforms.

Smart card: A general term for plastic cards (usually having a size of a credit card) with an embedded microchip. Some smart cards include a microelectronic chip. The smart card needs a reader and/or writer for data exchange. The smart card is equipped with a CPU, a RAM, and I/O, and can independently process a large amount of data without interfering with the work of the host CPU. The smart card can further filter out incorrect data to mitigate the burden of the host CPU, and is suitable for scenarios that include a large quantity of ports and need a high communication speed. The integrated circuits in the card include a central processing unit (CPU), a programmable read-only memory (EEPROM), a random access memory (RAM), and a chip operating system (COS) solidified in a read-only memory (ROM). The data in the card is divided into an external reading part and an internal processing part.

Chip operating system (COS): The COS is generally developed closely based on the characteristics of the smart card that the COS serves. The COS is a dedicated system rather than a general system, that is, one type of COS generally can be applied only to one (or more) particular smart cards. The COSs in different cards are generally different. Compared with those common operating systems on microcomputers, the COS is essentially closer to a temporary control program, rather than a so-called real operating system. At the current stage, the main problem that the COS needs to solve is still how to process and respond to external commands. It generally does not involve management and processing of sharing and concurrency. In addition, in terms of smart card applications, the work of sharing and concurrency is indeed unnecessary.

Applet: An application program unit, which is a mobile application developed on the mobile terminal platform based on the Java language, and is used to implement a service logic of the mobile terminal. The applet can be a form of COS.

APDU: short for application protocol data unit. The protocol data unit (PDU) is a data unit transferred between peer layers. The PDU of the physical layer is a data bit, the PDU of the data link layer is a data frame, the PDU of the network layer is a data packet, the PDU of the transport layer is a data segment, and the PDU of another higher layer is data.

Token: A token means temporary in computer identity authentication. It represents an object of a right to perform some operations. In general, the token can be called a secret signal. Before transmission of some data, the secret signal needs to be checked. Different secret signals are authorized for different data operations.

The present specification provides resource configuration methods. The present specification further relates to resource configuration apparatuses, resource configuration systems, computing devices, and computer-readable storage media, which are described one by one in detail in the following embodiments.

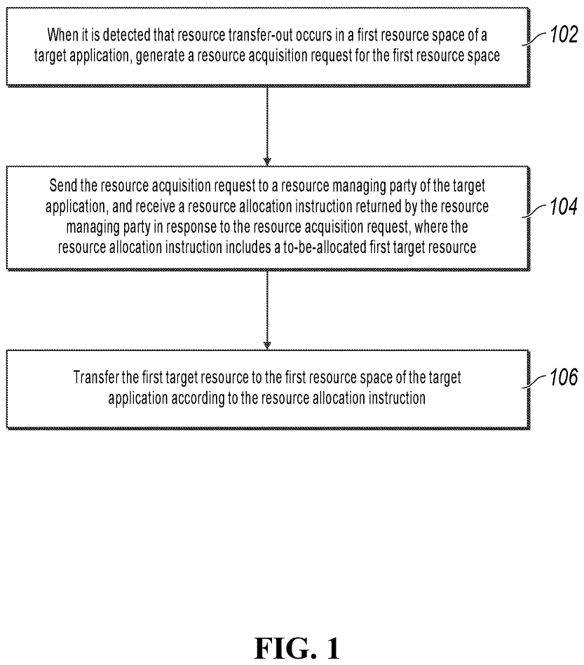

FIG. 1 is a flowchart illustrating a resource configuration method, according to some embodiments of the present specification. The method specifically includes the following steps:

Step 102: When it is detected that resource transfer-out occurs in a first resource space of a target application, generate a resource acquisition request for the first resource space.

In practice, a particular number of resources can be pre-stored in the resource space of the target application for subsequent resource transfer-out. During subsequent spending, the user can directly transfer a corresponding number of resources from the resource space to a resource receiver. However, in the previous process, resource pre-storage and resource transfer-out are two completely independent processes. It is necessary to regularly pay attention to the remaining resource in the resource space of the target application, and obtain a resource from the resource managing party in time for pre-storage. As a result, the remaining resource in the resource space may be insufficient and cannot be transferred out, causing inconvenience to the users.

The resource configuration method provided in the present specification includes the following: when it is detected that resource transfer-out occurs in a first resource space of a target application, generating a resource acquisition request for the first resource space; sending the resource acquisition request to a resource managing party of the target application, and receiving a resource allocation instruction returned by the resource managing party in response to the resource acquisition request, where the resource allocation instruction includes a to-be-allocated first target resource; and transferring the first target resource to the first resource space of the target application according to the resource allocation instruction. In this case, because the resource configured for the first resource space is used for subsequent resource transfer-out, that is, the behavior of obtaining the resource and the behavior of resource transfer-out are associated with each other, if resource transfer-out occurs in the first resource space, the resource acquisition operation can be directly and automatically initiated based on the result of the resource transfer-out, to request to obtain the resource from the resource managing party, and the user does not need to initiate the resource acquisition operation separately. This ensures that there is always a sufficient resource in the first resource space for resource transfer-out, and avoids consumption failure due to insufficient balance.

Specifically, the target application is an application of the resource transferor. For example, the target application can be a bus card application, an all-in-one card application, a meal card application, a rechargeable card application, etc. The first resource space is a space of the target application for storing a resource. The resource includes but is not limited to funds, a data resource, a computing resource, a virtual resource, etc. Resource transfer-out means transferring the resource in the first resource space to another resource space. The resource acquisition request is a request for obtaining a resource, that is, a request for increasing resource in the first resource space. For example, the resource is funds. The first resource space is an account of the target application for storing funds. The resource transfer-out means deducting a target amount of funds from the account. The resource acquisition request is a request for adding the funds to the account.

In practice, the present solution can be implemented by creating a virtual card such as a virtual bus card, a virtual meal card, etc. for the target application.

The process of creating the virtual card can include the following: receiving a virtual card application request for the target application; and when receiving virtual card application confirmation information, creating the virtual card for the target application, and associating the virtual card with the first resource space.

The transportation card is used as an example. In practice, an application portal for the virtual card can be provided through an NFC transportation card applet. In addition, a card receiving page can be used to display the card characteristics, prompting the user to agree on the card receiving, and then a withholding subscription page is used to prompt the user to subscribe to the withholding service. When the user completes the subscription to the withholding service, it is equivalent to sending application confirmation information of the transportation card. In this case, the subscription succeeds, and a card writing page is displayed for invoking the mobile phone service to start writing the card. The creation of the transportation card is completed.

After the creation is completed, the transportation card can be bound to the user's resource space. The user can subsequently use the transportation card to take public transportation.

Certainly, after the virtual card is created, if the target application does not need to be used later, the created virtual card can be deleted. The deleting method can include the following: receiving a virtual card return request; and when receiving virtual card return confirmation information, deleting data of the virtual card, and disassociating the virtual card from the first resource space.

The transportation card is still used as an example. It can still be implemented through the NFC transportation card applet. “Return card” is tapped on the card details page to invoke the mobile phone service to delete the data of the card. After the application corresponding to the transportation card returns the card balance to the user, the card return status is updated from returning the card to completion. During the card returning, it is further necessary to remove the first resource space associated with the transportation card.

It is worthwhile to note that, when it is detected that resource transfer-out occurs in the first resource space of a target application, it indicates that the resource in the first resource space decreases. In this case, the generation of the resource acquisition request for the first resource space can be automatically triggered to supplement the resource in the first resource space. The user does not need to initiate the resource acquisition operation separately. This ensures that there is always a sufficient resource in the first resource space for resource transfer-out.

In some optional implementations of these embodiments, the resource in the first resource space is transferred out only when the resource transfer-out instruction is received. Then it is detected that resource transfer-out occurs in the first resource space of the target application. Therefore, in the present specification, before generating the resource acquisition request for the first resource space, the method further includes the following: receiving a resource transfer-out instruction sent by a resource receiver, where the resource transfer-out instruction includes a second target resource to be transferred out; transferring the second target resource in the first resource space to a second resource space according to the resource transfer-out instruction, where the second resource space is a resource space corresponding to the resource receiver; and when the transfer-out of the second target resource is completed, determining that it is detected that the resource transfer-out occurs in the first resource space.

Specifically, the resource receiver refers to a party that receives the resource, the second resource space is a space of the resource receiver for storing the resource, and the resource transfer-out instruction is an instruction used to transfer the resource of the resource transferor to the resource receiver. For example, the resource receiver can be a bus card swiping machine, a metro gate machine, a meal card swiping machine, access control equipment, etc. The second target resource is a resource to be transferred out, that is, how much resource needs to be transferred from the first resource space to the second resource space. For example, the resource is funds. If the resource receiver spends 20 yuan, that is, the second target resource is 20 yuan, the resource transfer-out instruction sent by the resource receiver to transfer out 20 yuan is received in this case. After the resource transfer-out instruction is received, 20 yuan is transferred from the first resource space to the second resource space. After the transfer-out is completed, the funds in the first resource space decrease by 20 yuan. At this time, it can be determined that the resource transfer-out behavior in the first resource space is detected.

In some optional implementations of these embodiments, the resource transfer-out instruction sent by the resource receiver can further include first verification information, so that after receiving the resource transfer-out instruction, the resource transferor can first verify validity of the identity of the resource receiver. After the verification succeeds, the resource is transferred out. The specific implementation process can be as follows: verifying the resource transfer-out instruction based on the first verification information, and when the verification succeeds, performing the operation step of transferring the second target resource in the first resource space to a second resource space according to the resource transfer-out instruction.

Specifically, the first verification information is generated by the resource receiver and can represent the identity information of the resource receiver. For example, the first verification information can be a token, and the token can be a device address of the resource receiver. A communication connection is established between the resource receiver and the resource transferor before the resource transfer-out. After the communication connection is established, the resource receiver can send a resource transfer-out instruction to the resource transferor, and the resource transferor verifies the identity of the resource receiver after receiving the resource transfer-out instruction. After the verification succeeds, the resource is transferred out. If the verification fails, the resource is not transferred out.

In the present specification, the first verification information included in the received resource transfer-out instruction can be verified, so as to verify validity of the identity of the resource receiver. The resource is transferred out only when the verification of the validity of the identity of the resource receiver succeeds, thereby ensuring the resource security of the resource transferor.

In some optional implementations of these embodiments, the resource transfer-out can be performed normally only when the resource in the first resource space is sufficient for the resource transfer-out. Therefore, it is necessary to check the resource in the first resource space before the resource is transferred out. The specific implementation process can be as follows: determining whether a resource in the first resource space is greater than or equal to the second target resource, and if yes, performing the operation step of transferring the second target resource in the first resource space to a second resource space according to the resource transfer-out instruction.

It is worthwhile to note that the second target resource is a resource to be transferred out, so it can be determined whether the resource in the first resource space is greater than or equal to the second target resource. If yes, it indicates that the resource in the first resource space is sufficient to support the current resource transfer-out. In this case, the operation step of transferring the second target resource in the first resource space to the second resource space is performed normally, and the resource transfer-out succeeds. If the resource in the first resource space is not greater than or equal to the second target resource, it indicates that the resource in the first resource space cannot support the current resource transfer-out. In this case, the operation step of transferring the second target resource in the first resource space to the second resource space is not performed, and the resource transfer-out fails.

In some optional implementations of these embodiments, after the transferring the second target resource in the first resource space to a second resource space, the method further includes the following: generating a first resource transfer response message that includes fifth verification information; and sending the first resource transfer response message to the resource managing party.

Specifically, the fifth verification information is generated by the resource transferor (the target application), and represents identity information that behavior of the resource transferor to transfer out the resource is valid. For example, the fifth verification information can alternatively be a token. The first resource transfer response message refers to a result of the resource transfer-out, that is, a transfer-out certificate. Because the resource managing party manages the resource of the resource transferor, if the second target resource in the first resource space is transferred to the second resource space, the resource managing party needs to be notified to synchronize the resource transfer-out operation and update the resource of the first resource space stored by the resource managing party.

In some optional implementations of these embodiments, after the resource transfer-out is completed, the resource acquisition request for the first resource space can be directly and automatically generated. In other words, as long as the resource transfer-out occurs in the first resource space, the resource acquisition operation is directly initiated, that is, the resource is obtained while the resource is being transferred out.

In some optional implementations of these embodiments, after the resource transfer-out is completed, whether to initiate the resource acquisition request or not can also be determined based on the remaining resource in the first resource space. The specific implementation process can be as follows: when the transfer-out of the second target resource is completed, determining whether a remaining resource in the first resource space is greater than a predetermined threshold, and if no, generating the resource acquisition request for the first resource space.

Specifically, the predetermined threshold is a predetermined value used to determine whether to initiate the resource acquisition request. For example, the predetermined threshold can be 20, 30, 50, etc. In the present specification, after the resource in the first resource space is transferred to the second resource space, it can be determined whether the remaining resource in the first resource space is greater than the predetermined threshold. If no, it indicates that there is few remaining resources in the first resource space. In this case, the resource acquisition request for the first resource space can be generated. If the remaining resource in the first resource space is greater than the predetermined threshold, it indicates that there are more remaining resources in the first resource space. In this case, the resource acquisition request for the first resource space may not be generated, that is, no resource acquisition operation is performed.

In some optional implementations of these embodiments, when the resource acquisition request for the first resource space is generated, the resource acquisition request can further include verification information to prove the validity of the resource acquisition request. The specific implementation process can be as follows: generating a resource acquisition verification factor for obtaining a resource, and generating second verification information; generating third verification information based on a result of the resource transfer-out and the resource acquisition verification factor; and generating the resource acquisition request based on the second verification information and the third verification information.

Specifically, the resource acquisition verification factor refers to the identity verification information generated by the resource transferor (the target application) after the resource is transferred out. The result of the resource transfer-out refers to a certificate for the resource transfer-out. The resource transfer-out occurs in the first resource space, proving that valid resource acquisition can be performed in the first resource space. Therefore, the third verification information can be generated jointly based on the result of the resource transfer-out and the resource acquisition verification factor, and the third verification information is used to prove that the resource acquisition behavior is valid.

In addition, the second verification information is information generated by the resource transferor for subsequently verifying whether the resource managing party is valid. The second verification information can be a random number generated by the resource transferor, and the resource transferor adds the random number to the resource acquisition request and sends the resource acquisition request to the resource managing party. Then, the resource managing party can encrypt the random number, and then add the random number to the resource allocation instruction and return the resource allocation instruction to the resource transferor. The resource transferor decrypts the random number and determines whether the random number is the same as the previously generated random number, so as to verify whether the identity of the resource managing party is valid.

In the present specification, when the resource acquisition request is generated, the resource acquisition request includes not only the third verification information used to verify whether the resource acquisition behavior is valid, but also the second verification information used to subsequently verify whether the identity of the resource managing party is valid, thereby greatly ensuring the security of the entire resource acquisition process.

Moreover, in addition to including the second verification information and the third verification information, the resource acquisition request can further include other parameters based on different application scenarios, so as to avoid repeatedly sending the resource allocation instruction for one task multiple times. For example, in a transaction scenario, a resource acquisition request is generated after a transaction is generated. The resource acquisition request can include parameter information such as transaction time, a transaction serial number, a transaction device, etc. in addition to including the verification information such as the random number and the resource acquisition verification factor, so that after subsequently receiving the resource acquisition request, the resource managing party can verify and analyze the resource acquisition request, ensuring that the resource managing party sends the resource allocation instruction only once for the same transaction task.

In some optional implementations of these embodiments, after the resource transfer-out is completed, the result of the resource transfer-out can be returned to the resource receiver. The specific implementation process can be as follows: generating a third resource transfer response message based on the third verification information; and sending the third resource transfer response message to the resource receiver.

It is worthwhile to note that the third resource transfer response message refers to the result of the resource transfer-out of the resource transferor, that is, whether the resource was successfully transferred out. Because the third verification information is generated based on the result of the resource transfer-out and the resource acquisition verification factor, the third verification information includes not only the identity verification information generated by the resource transferor after the resource is transferred out, but also the certificate for the resource transfer-out. Therefore, the third resource transfer response message can be generated directly based on the third verification information. After receiving the third resource transfer response message, the resource receiver can verify the identity of the resource transferor based on the third verification information, and obtain the result of the resource transfer-out.

Step 104: Send the resource acquisition request to a resource managing party of the target application, and receive a resource allocation instruction returned by the resource managing party in response to the resource acquisition request, where the resource allocation instruction includes a to-be-allocated first target resource.

Specifically, the resource managing party is a party that manages the resource of the target application, that is, the resource managing party stores the resource in the first resource space of the target application. For example, the resource managing party can be a server of the target application. The first target resource is a to-be-allocated resource, that is, how much resource needs to be allocated to the first resource space. For example, the resource is funds. The first target resource included in the resource allocation instruction can be 100 yuan. The resource allocation instruction is an instruction for allocating a resource to the first resource space of the target application. The resource allocation instruction can be an APDU instruction. The APDU instruction can include multiple identification parameters, and each identification parameter indicates a specific operation of resource transfer.

It is worthwhile to note that in the present specification, the resource transfer-out behavior and the resource acquisition behavior for the first resource space of the target application are associated, and resource acquisition is automatically initiated as long as it is detected that resource transfer-out occurs in the first resource space. In addition, the number of resources transferred out from the first resource space and the number of resources transferred to the first resource space are not limited in the present specification, and they can be the same or different. That is, the first target resource and the second target resource can be the same or different, or can be both predetermined. This is not limited in the present specification.

In other words, in the present specification, when a quantity of resources are transferred out from the first resource space, the quantity of resources can be obtained from the resource managing party through application, or a predetermined multiple of the quantity of transferred-out resources can be obtained from the resource managing party through application. For example, in a payment deduction scenario, assuming that 100 yuan is deducted from a first funds account, a recharge request can be automatically initiated in this case, requesting to recharge 100 yuan to the first funds account, or requesting to recharge 200 yuan to the first funds account.

Step 106: Transfer the first target resource to the first resource space of the target application according to the resource allocation instruction.

It is worthwhile to note that after the resource allocation instruction returned by the resource managing party is received, it indicates that the resource managing party has agreed on the resource acquisition request. In this case, the resource allocation instruction can be executed directly based on a parameter included in the resource allocation instruction. For example, the first target resource is 100 yuan, and 100 yuan can be added to the first resource space of the target application in this case. In some optional implementations of these embodiments, when the resource managing party returns the resource allocation instruction, the resource allocation instruction can include fourth verification information to prove that the identity of the resource managing party is valid. In this case, when the first target resource is transferred to the first resource space of the target application according to the resource allocation instruction, the fourth verification information included in the resource allocation instruction needs to be verified first. The specific implementation process can be as follows: verifying the resource allocation instruction based on the fourth verification information included in the resource allocation instruction, and when the verification succeeds, performing the operation step of transferring the first target resource to the first resource space of the target application according to the resource allocation instruction.

Specifically, the fourth verification information is generated by the resource managing party based on the second verification information and the third verification information, and is used to verify whether the identity of the resource managing party is valid.

In the present specification, when the resource allocation instruction is received, the fourth verification information included in the resource allocation instruction can be verified first, and the resource allocation instruction is executed only after the verification succeeds, thereby greatly ensuring the security of the entire resource acquisition process.

In some optional implementations of these embodiments, after the transferring the first target resource to the first resource space of the target application according to the resource allocation instruction, the method further includes the following: generating a second resource transfer response message that includes sixth verification information; and sending the second resource transfer response message to the resource managing party.

Specifically, the sixth verification information is generated by the resource transferor (the target application), and represents the identity information of the resource transferor. For example, the sixth verification information can alternatively be a token. The second resource transfer response message refers to the result of adding a resource to the first resource space. Because the resource managing party manages the resource of the resource transferor, if the first target resource is transferred to the first resource space of the target application, the resource managing party needs to be notified to synchronize the resource transfer operation and update the resource of the first resource space stored by the resource managing party.

The resource configuration method provided in the present specification includes the following: when it is detected that resource transfer-out occurs in a first resource space of a target application, generating a resource acquisition request for the first resource space; sending the resource acquisition request to a resource managing party of the target application, and receiving a resource allocation instruction returned by the resource managing party in response to the resource acquisition request, where the resource allocation instruction includes a to-be-allocated first target resource; and transferring the first target resource to the first resource space of the target application according to the resource allocation instruction. In this case, because the resource configured for the first resource space is used for subsequent resource transfer-out, that is, the behavior of obtaining the resource and the behavior of resource transfer-out are associated with each other, if resource transfer-out occurs in the first resource space, the resource acquisition operation can be directly and automatically initiated based on the result of the resource transfer-out, to request to obtain the resource from the resource managing party, and the user does not need to initiate the resource acquisition operation separately. This ensures that there is always a sufficient resource in the first resource space for resource transfer-out, avoids consumption failure due to insufficient balance, facilitates the user's operation, and improves the user experience.

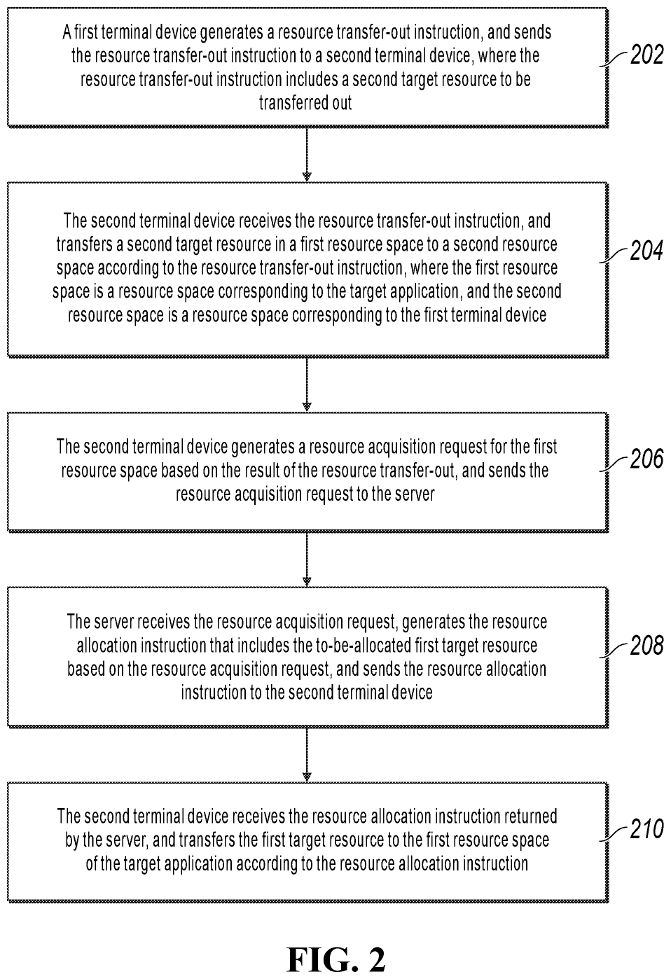

With reference to FIG. 2, the following further describes the resource configuration method provided in the present specification by using the application of the resource configuration method in the terminal device as an example. FIG. 2 is a processing flowchart illustrating a resource configuration method applied to a terminal device, according to some embodiments of the present specification. The method specifically includes the following steps:

Step 202: A first terminal device generates a resource transfer-out instruction, and sends the resource transfer-out instruction to a second terminal device, where the resource transfer-out instruction includes a second target resource to be transferred out.

Specifically, the first terminal device can be a device of the resource receiver, such as a bus card swiping machine, a metro gate machine, a meal card swiping machine, access control equipment, etc.; the second terminal device can be a device of the resource transferor, such as a mobile terminal (a mobile phone, a tablet computer, a band, etc.) used by the user. A communication connection is established between the first terminal device and the second terminal device. During specific implementation, the first terminal device can implement connection through (but not limited to) near field communication (NFC).

In addition, the target application is an application of the resource transferor, including but not limited to an electronic bus card application and an electronic meal card application. The second terminal device is configured with the target application, that is, the target application can be in communication connection with the second terminal device, or can be installed directly on the second terminal device. For example, the target application can be a COS application configured in a smart card, and the smart card can be in communication connection with the second terminal device. In this case, the second terminal device is configured with the target application. Alternatively, the target application can be an application program (applet) installed in the second terminal device, and the application program (applet) is actually a COS application.

In some optional implementations of these embodiments, before the first terminal device generates the resource transfer-out instruction, it should be first determined whether there is a corresponding target application in the second terminal device. Therefore, the first terminal device should send an application selection instruction to the second terminal device in advance, instructing the second terminal device to identify the corresponding target application and return a response message. The specific implementation process is as follows: the first terminal device sends an application selection instruction that includes a device identifier of the first terminal device to the second terminal device, and receives an application response message returned by the second terminal device; the second terminal device determines a corresponding target application based on the device identifier included in the received application selection instruction, and sends the application selection instruction to the target application; and then obtains an application response message returned by the target application, and sends the application response message to the first terminal device; and the first terminal device generates the resource transfer-out instruction when receiving the application response message.

Specifically, the device identifier can uniquely identify the first terminal device, and the corresponding target application can be determined based on the device identifier. It is worthwhile to note that the first terminal device is the resource receiver. Generally, the resource receiver has a corresponding resource transferor. The resource transferor usually implements resource storage and transfer through an application. For example, if the first terminal device is a metro gate machine, the corresponding metro card application needs to be identified in the second terminal device; if the first terminal device is a bus card swiping machine, the corresponding bus card application needs to be identified in the second terminal device.

In the present specification, the first terminal device can send an application selection instruction that includes the device identifier of the first terminal device to the second terminal device. After receiving the application selection instruction, the second terminal device searches whether there is a corresponding target application. When the corresponding target application is identified, the application selection instruction is passed through to the target application. After receiving the application selection instruction, the target application can return an application response message to the second terminal device, indicating that the target application has known that the resource is to be transferred out, and the second terminal device forwards the application response message to the first terminal device. In this case, the first terminal device understands that there is a target application capable of transferring out the resource in the second terminal device, and generates a resource transfer-out instruction.

Step 204: The second terminal device receives the resource transfer-out instruction, and transfers a second target resource in a first resource space to a second resource space according to the resource transfer-out instruction, where the first resource space is a resource space corresponding to the target application, and the second resource space is a resource space corresponding to the first terminal device.

Specifically, the first resource space is a resource storage space of the target application configured in the second terminal device of the resource transferor. The second resource space is a resource storage space of the first terminal device of the resource receiver.

In some optional implementations of these embodiments, the resource transfer-out instruction sent by the first terminal device can further include the first verification information, so that the target application of the second terminal device can first verify the validity of the identity of the first terminal device after receiving the resource transfer-out instruction, and then transfer out the resource after the verification succeeds. The specific implementation process can be as follows: when receiving the resource transfer-out instruction, the target application of the second terminal device can verify the resource transfer-out instruction based on the first verification information, and when the verification succeeds, perform the operation step of transferring a second target resource in a first resource space to a second resource space according to the resource transfer-out instruction.

It is worthwhile to note that after the first terminal device sends the resource transfer-out instruction to the second terminal device, the second terminal device (a transceiver module) can pass through the resource transfer-out instruction to the target application, and then the target application can verify the resource transfer-out instruction, and execute the resource transfer-out instruction when the verification succeeds.

In the present specification, the first verification information included in the received resource transfer-out instruction can be verified, so as to verify validity of the identity of the first terminal device. The resource is transferred out only when the verification of the validity of the identity of the first terminal device succeeds, thereby ensuring the security of the resource in the target application of the second terminal device.

In some optional implementations of these embodiments, the resource transfer-out can be performed normally only when the resource in the first resource space is sufficient for the resource transfer-out. Therefore, it is necessary to check the resource in the first resource space before the resource is transferred out. The specific implementation process can be as follows:

when receiving the resource transfer-out instruction, the target application of the second terminal device determines whether a resource in the first resource space is greater than or equal to the second target resource, and if yes, performs the operation step of transferring a second target resource in a first resource space to a second resource space.

In some optional implementations of these embodiments, after the target application of the second terminal device transfers the second target resource in the first resource space to the second resource space, the method further includes the following: the target application of the second terminal device generates a first resource transfer response message that includes fifth verification information, and sends the first resource transfer response message to the server; and the server verifies the first resource transfer response message based on the fifth verification information included in the received first resource transfer response message, and when the verification succeeds, updates a resource in the first resource space.

The server is a server for the resource management service of the target application. In other words, the server manages the resource of the target application. Therefore, if the second target resource in the first resource space of the target application is transferred to the second resource space, the server needs to be notified to synchronize the resource transfer-out operation and update the resource of the first resource space stored by the server.

In some optional implementations of these embodiments, after the resource transfer-out is completed, the target application of the second terminal device can return the result of the resource transfer-out to the server. The specific implementation process can be as follows: the target application of the second terminal device generates a third resource transfer response message based on the third verification information, and sends the third resource transfer response message to the first terminal device; and the first terminal device generates and displays a result of the resource transfer-out based on the received third resource transfer response message.

For example, the resource space of the metro card application transfers 5 yuan to the resource space corresponding to the metro gate machine device. After the transfer-out succeeds, the metro card application generates a third resource transfer response message, and the message indicates that 5 yuan was successfully transferred to the resource space corresponding to the metro gate machine device. After receiving the third resource transfer response message, the metro gate machine device displays fee deduction success and opens the gate to allow the user to pass.

Step 206: The second terminal device generates a resource acquisition request for the first resource space based on the result of the resource transfer-out, and sends the resource acquisition request to the server.

It is worthwhile to note that the second terminal device receives the resource transfer-out instruction, and transfers the second target resource in the first resource space to the second resource space according to the resource transfer-out instruction. There are two results of the resource transfer-out: transfer-out success and transfer-out failure. If the transfer-out succeeds, it indicates that the resource in the first resource space decreases. In this case, it can be determined that the resource transfer-out is detected in the first resource space of the target application, and the generation of the resource acquisition request for the first resource space is automatically triggered to supplement the resource in the first resource space. In this case, as long as the resource transfer-out occurs in the first resource space, the resource acquisition operation is directly initiated, that is, the resource is obtained while the resource is being transferred out. This always ensures that there is a sufficient resource in the first resource space.

If the transfer-out fails, it indicates that the resource in the first resource space may not change, and the resource acquisition request does not have to be generated. However, if the target application further determines whether the resource in the first resource space can support the current resource transfer-out before the resource is transferred out, and if the resource in the first resource space is less than the second target resource, the resource transfer-out instruction is not executed and the transfer-out fails. Such transfer-out failure is caused by resource insufficiency in the first resource space. A resource needs to be obtained. Therefore, in this case, the target application can generate an indicator for resource insufficiency. If the indicator is detected, it can also be determined that the resource transfer-out is detected in the first resource space of the target application, and a resource acquisition request for the first resource space is generated.

In some optional implementations of these embodiments, after the transfer-out of the second target resource is completed, whether to initiate the resource acquisition request or not can also be determined based on the remaining resource in the first resource space. The specific implementation process can be as follows: the target application of the second terminal device determines whether a remaining resource in the first resource space is greater than a predetermined threshold, and if no, generates the resource acquisition request for the first resource space.

In some optional implementations of these embodiments, when the target application of the second terminal device generates the resource acquisition request for the first resource space, the resource acquisition request can further include verification information to prove the validity of the resource acquisition request. The specific implementation process can be as follows: generating a resource acquisition verification factor for obtaining a resource, and generating second verification information; and generating third verification information based on a result of the resource transfer-out and the resource acquisition verification factor, and adding the second verification information and the third verification information to the resource acquisition request.

In the present specification, when the target application of the second terminal device generates the resource acquisition request, the resource acquisition request includes not only the third verification information used to verify whether the resource acquisition behavior is valid, but also the second verification information used to subsequently verify whether the identity of the resource managing party is valid, thereby greatly ensuring the security of the entire resource acquisition process.

Step 208: The server receives the resource acquisition request, generates the resource allocation instruction that includes the to-be-allocated first target resource based on the resource acquisition request, and sends the resource allocation instruction to the second terminal device.

During specific implementation, after the server receives the resource acquisition request, it indicates that the server has understood that the target application wants to obtain the resource. In this case, the server can verify the resource acquisition request, and when the verification succeeds, generate a resource allocation instruction and send the resource allocation instruction to the target application of the second terminal device, indicating that the server agrees to the target application to obtain the resource. The specific implementation process can be as follows: verifying the resource acquisition request based on the third verification information included in the resource acquisition request, and when the verification succeeds, generating fourth verification information based on the second verification information and the third verification information; and adding the fourth verification information to the resource allocation instruction.

It is worthwhile to note that the third verification information is generated by the target application jointly based on the result of the resource transfer-out and the resource acquisition verification factor, and is used to verify whether the resource acquisition behavior is valid. Therefore, after receiving the resource acquisition request, the server only needs to verify the third verification information in the resource acquisition request, so as to determine whether the resource acquisition behavior is valid. The second verification information is a random number generated by the target application of the second terminal device, and is used for subsequent verification of the identity of the server. Therefore, the server only needs to encrypt the second verification information and then return it to the second terminal device. When the verification of the third verification information succeeds, the server can generate fourth verification information based on the second verification information and the third verification information, and add the fourth verification information to the resource allocation instruction and return the resource allocation instruction to the second terminal device.

Step 210: The second terminal device receives the resource allocation instruction returned by the server, and transfers the first target resource to the first resource space of the target application according to the resource allocation instruction.

During specific implementation, when the server returns the resource allocation instruction, the resource allocation instruction can include fourth verification information to prove that the identity of the server is valid. In this case, when the target application of the second terminal device transfers the first target resource to the first resource space of the target application according to the resource allocation instruction, the target application of the second terminal device needs to first verify the fourth verification information included in the resource allocation instruction. The specific implementation process can be as follows: verifying the resource allocation instruction based on the fourth verification information included in the resource allocation instruction, and when the verification succeeds, performing the operation step of transferring the first target resource to the first resource space of the target application according to the resource allocation instruction.

In some optional implementations of these embodiments, after the second terminal device transfers the first target resource to the first resource space of the target application according to the resource allocation instruction, the method further includes the following: the target application of the second terminal device generates a second resource transfer response message that includes sixth verification information, and sends the second resource transfer response message to the server; and the server verifies the second resource transfer response message based on the sixth verification information included in the received second resource transfer response message, and when the verification succeeds, updates a resource in the first resource space.

It is worthwhile to note that because the server manages the resource of the target application, if the first target resource was successfully transferred to the first resource space of the target application, the server needs to be notified to synchronize the resource transfer operation and update the resource of the first resource space stored by the server.

According to the resource configuration method provided in the present specification, the first terminal device generates the resource transfer-out instruction, and sends the resource transfer-out instruction to the second terminal device; the second terminal device receives the resource transfer-out instruction, and transfers the second target resource in the first resource space to the second resource space according to the resource transfer-out instruction, and generates the resource acquisition request for the first resource space based on the result of the resource transfer-out, and sends the resource acquisition request to the server; the server receives the resource acquisition request, generates the resource allocation instruction that includes the to-be-allocated first target resource based on the resource acquisition request, and sends the resource allocation instruction to the second terminal device; the second terminal device receives the resource allocation instruction returned by the server, and transfers the first target resource to the first resource space of the target application according to the resource allocation instruction. In this case, because the resource configured for the first resource space is used for subsequent resource transfer-out, that is, the behavior of obtaining the resource and the behavior of resource transfer-out are associated with each other, if resource transfer-out occurs in the first resource space, the resource acquisition operation can be directly and automatically initiated based on the result of the resource transfer-out, to request to obtain the resource from the server, and the user does not need to initiate the resource acquisition operation separately. This ensures that there is always a sufficient resource in the first resource space for resource transfer-out, avoids consumption failure due to insufficient balance, facilitates the user's operation, and improves the user experience.

FIG. 2 shows a schematic solution of a resource configuration method according to some embodiments. It is worthwhile to note that the technical solution of the resource configuration method belongs to the same concept as the technical solution of the previous resource configuration method shown in FIG. 1. For details that are not described in detail in the technical solution of the resource configuration method shown in FIG. 2, references can be made to the description of the technical solution of the previous resource configuration method shown in FIG. 1.

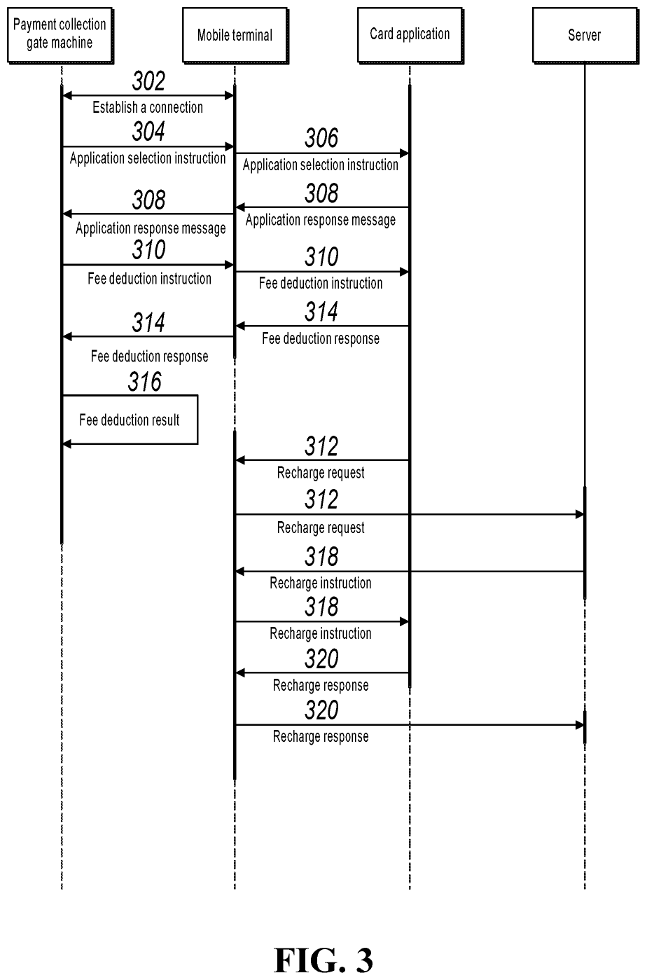

With reference to FIG. 3, the following further describes the resource configuration method provided in the present specification by using the application of the resource configuration method in the public transportation scenario as an example. FIG. 3 is an interaction diagram illustrating a resource configuration method applied to a public transportation scenario, according to some embodiments of the present specification. The method specifically includes the following steps:

Step 302: After the mobile terminal approaches a payment collection gate machine, the payment collection gate machine triggers establishment of a communication connection with the mobile terminal through near field communication.

In practice, a variety of solutions have emerged in the field of public transportation to serve various travel payments, such as taking bus through mobile NFC, taking metro using a non-contact smart card, taking bus using a two-dimensional code, and taking metro using a two-dimensional code. Many methods have their own advantages. The two-dimensional code application reduces the pre-recharge step for people during travel and realizes riding before payment. However, the user cannot open or refresh the two-dimensional code when there is no network or network signals are poor, as a result, often causing people failure to ride. The mobile phone NFC and the smart card also have their own advantages. They enable passengers to take bus or metro and travel quickly in a short period of time, but they need to be recharged in advance. If the balance is insufficient, failure to ride occurs. In other words, the recharge service and the consumption service of existing card applications are two independent processes.

The present specification provides a resource configuration method, in which an application portal for the virtual card can be provided through an NFC transportation card applet of the mobile terminal. A card receiving page is used to display the card characteristics, prompting the user to agree on the card receiving, and then a withholding subscription page is used to prompt the user to subscribe to the withholding service. When the user completes the subscription to the withholding service, it is equivalent to sending application confirmation information of the transportation card. In this case, the subscription succeeds, and a card writing page is displayed for invoking the mobile phone service to start writing the card. The creation of the transportation card is completed. After the creation is completed, the transportation card can be bound to the user's resource space. The user can subsequently use the transportation card to take public transportation.

When a deduction in a funds account of a card application is detected, a recharge request for the funds account is generated; the recharge request is sent to the server, and a recharge instruction returned by the server in response to the recharge request is received; and the card application can recharge funds to the funds account according to the recharge instruction. In this case, the card application directly associates the fee deduction behavior and the recharge behavior in the funds account in the card. If a deduction occurs in the funds account of the card application, the recharge process can be directly and automatically triggered based on the result of the fee deduction. The card application proactively notifies the mobile terminal of the behavior, and the mobile terminal initiates a funds recharge request to request recharge funds from the server. The user does not need to initiate a recharge operation separately, ensuring that there are always sufficient funds in the funds account of the card application for consumption.

Specifically, the payment collection gate machine includes but is not limited to the metro gate machine, and the mobile terminal includes but is not limited to the mobile phone or the tablet computer. In addition, both the payment collection gate machine and the mobile terminal have the NFC function. The user moves the mobile terminal close to the payment collection gate machine, and the payment collection gate machine can recognize the mobile terminal and establish a connection with the mobile terminal.

During specific implementation, the payment collection gate machine can establish a communication connection request through near field communication, where the communication connection request includes a communication parameter; after approaching the payment collection gate machine, the mobile terminal can receive and respond to the communication connection request, and establish a communication connection with the payment collection gate machine based on the communication parameter.

It is worthwhile to note that NFC is a non-contact radio technology with a short distance and a high frequency. Generally, the frequency band used by NFC can be 13.56 MHz, and the operating distance is usually within 10 cm. When an NFC chip is started, it can continuously emit radio frequency signals. An NFC tag is a coil that data can be written into. When the coil is in contact with the radio frequency signal emitted by the NFC chip, the coil can generate a signal that includes the written data. A reader in the NFC chip can read the signal and obtain the included data through parsing.

Both the payment collection gate machine and the mobile terminal have a built-in NFC module. The payment collection gate machine continuously emits radio frequency signals through the NFC module to establish a communication connection request. The communication connection request includes the device information of the payment collection gate machine. After approaching the payment collection gate machine, the mobile terminal receives and responds to the communication connection request, and establishes a communication connection with the mobile terminal based on the device information of the payment collection gate machine.

Step 304: The payment collection gate machine sends an application selection instruction that includes a device identifier of the payment collection gate machine to the mobile terminal.

Step 306: The mobile terminal determines the corresponding card application based on the device identifier included in the received application selection instruction, and sends the application selection instruction to the card application.

Step 308: After receiving the application selection instruction, the card application returns an application response message to the payment collection gate machine via the mobile terminal.

Step 310: The payment collection gate machine generates a fee deduction instruction, and sends the fee deduction instruction to the card application via the mobile terminal.

Step 312: The card application receives the fee deduction instruction, and deducts first target funds from the funds account of the card application according to the fee deduction instruction. While the card application deducts funds, the card application generates a recharge request for the funds account of the card application based on the result of the funds deduction, and sends the recharge request to the server via the mobile terminal.

Step 314: The card application generates a fee deduction response, and sends the fee deduction response to the payment collection gate machine via the mobile terminal, so as to notify the payment collection gate machine of the fee deduction response. Then, the payment collection gate machine notifies the corresponding server of the fee deduction response, and the server adds the fee to the funds account corresponding to the payment collection gate machine.

Step 316: The payment collection gate machine generates and displays a fee deduction result based on the received fee deduction response.

Step 318: The server receives the recharge request, generates a recharge instruction based on the recharge request, and sends the recharge instruction to the card application via the mobile terminal.

Step 320: The card application receives the recharge instruction returned by the server, recharges the second target amount of funds to the funds account of the card application according to the recharge instruction, generates a recharge response, and sends the recharge response to the server via the mobile terminal.

Certainly, after the virtual card is created, if the target application does not need to be used later, the created virtual card can be deleted. The deleting method can include the following: receiving a virtual card return request; and when receiving virtual card return confirmation information, deleting data of the virtual card, and disassociating the virtual card from the first resource space.

The transportation card is still used as an example. It can still be implemented through the NFC transportation card applet. “Return card” is tapped on the card details page to invoke the mobile phone service to delete the data of the card. After the application corresponding to the transportation card returns the card balance to the user, the card return status is updated from returning the card to completion. During the card returning, it is further necessary to remove the first resource space associated with the transportation card.

According to the resource configuration method provided in the present specification, because the funds recharged to the funds account of the card application are used for subsequent spending, that is, the funds recharge behavior and the spending behavior are associated with each other. Therefore, if a deduction occurs in the funds account of the card application, the funds recharge request can be directly and automatically triggered based on the result of the fee deduction to request recharge funds from the server. The user does not need to initiate a recharge operation separately, ensuring that there are always sufficient funds in the funds account of the card application for consumption, avoiding consumption failure due to insufficient balance, facilitating the user's operation, and improving the user experience.

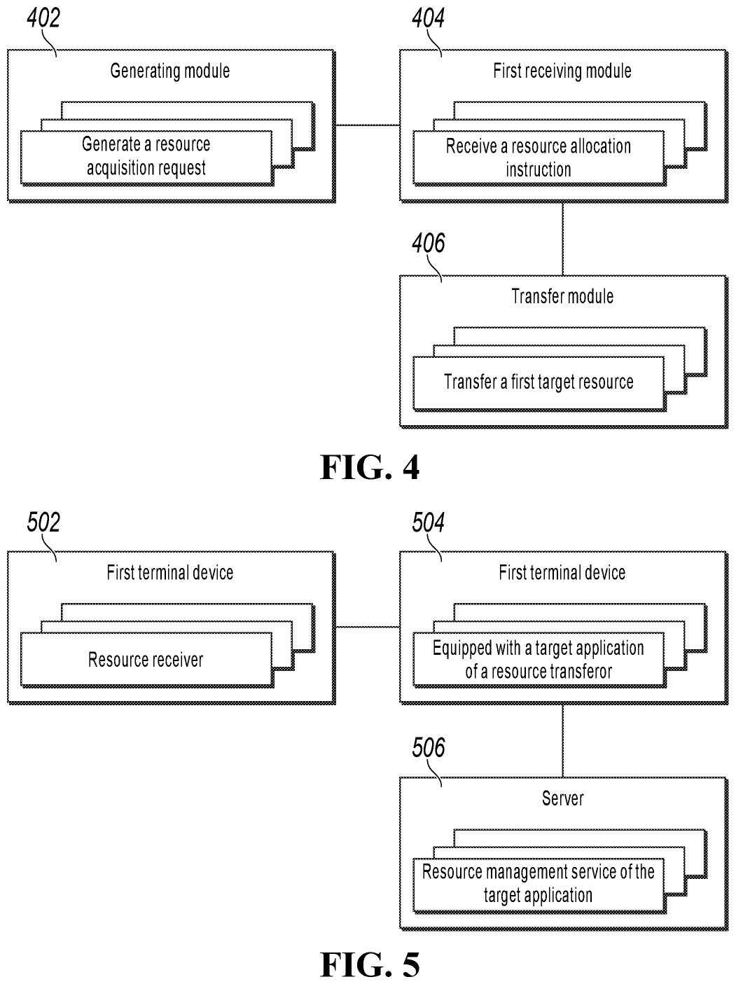

Corresponding to the previous embodiments of the resource configuration method shown in FIG. 1, the present specification further provides some embodiments of a resource configuration apparatus. FIG. 4 is a schematic structural diagram illustrating a resource configuration apparatus, according to some embodiments of the present specification. As shown in FIG. 4, the apparatus includes the following: a generating module 402, configured to: when it is detected that resource transfer-out occurs in a first resource space of a target application, generate a resource acquisition request for the first resource space; a first receiving module 404, configured to send the resource acquisition request to a resource managing party of the target application, and receive a resource allocation instruction returned by the resource managing party in response to the resource acquisition request, where the resource allocation instruction includes a to-be-allocated first target resource; and a transfer module 406, configured to transfer the first target resource to the first resource space of the target application according to the resource allocation instruction.

Optionally, the generating module 402 is further configured to: generate a resource acquisition verification factor for obtaining a resource, and generate second verification information; and generate third verification information based on a result of the resource transfer-out and the resource acquisition verification factor; and generate the resource acquisition request based on the second verification information and the third verification information.

Optionally, the transfer module 406 is further configured to: verify the resource allocation instruction based on the fourth verification information included in the resource allocation instruction, and when the verification succeeds, perform the operation step of transferring the first target resource to the first resource space of the target application according to the resource allocation instruction.

Optionally, the apparatus further includes the following: a second receiving module, configured to receive a resource transfer-out instruction sent by a resource receiver, where the resource transfer-out instruction includes a second target resource to be transferred out; a transfer-out module, configured to transfer the second target resource in the first resource space to a second resource space according to the resource transfer-out instruction, where the second resource space is a resource space corresponding to the resource receiver; and a determination module, configured to: when the transfer-out of the second target resource is completed, determine that it is detected that the resource transfer-out occurs in the first resource space.

Optionally, the apparatus further includes the following: a verification module, configured to verify the resource transfer-out instruction based on the first verification information, and when the verification succeeds, perform the operation step of transferring the second target resource in the first resource space to a second resource space according to the resource transfer-out instruction.

Optionally, the apparatus further includes the following: a first determination module, configured to determine whether a resource in the first resource space is greater than or equal to the second target resource, and if yes, perform the operation step of transferring the second target resource in the first resource space to a second resource space according to the resource transfer-out instruction.

Optionally, the apparatus further includes the following: a second determination module, configured to: when the transfer-out of the second target resource is completed, determine whether a remaining resource in the first resource space is greater than a predetermined threshold, and if no, generate the resource acquisition request for the first resource space.

Optionally, the apparatus further includes the following: a first generating module, configured to generate a first resource transfer response message that includes fifth verification information; and a first sending module, configured to send the first resource transfer response message to the resource managing party.

Optionally, the apparatus further includes the following: a second generating module, configured to generate a second resource transfer response message that includes sixth verification information; and a second sending module, configured to send the second resource transfer response message to the resource managing party.

Optionally, the generating module 402 is further configured to: generate a third resource transfer response message based on the third verification information; and send the third resource transfer response message to the resource receiver.

The resource configuration apparatus provided in the present specification is configured to: when it is detected that resource transfer-out occurs in a first resource space of a target application, generate a resource acquisition request for the first resource space; send the resource acquisition request to a resource managing party of the target application, and receive a resource allocation instruction returned by the resource managing party in response to the resource acquisition request, where the resource allocation instruction includes a to-be-allocated first target resource; and transfer the first target resource to the first resource space of the target application according to the resource allocation instruction. In this case, because the resource configured for the first resource space is used for subsequent resource transfer-out, that is, the behavior of obtaining the resource and the behavior of resource transfer-out are associated with each other, if resource transfer-out occurs in the first resource space, the resource acquisition operation can be directly and automatically initiated based on the result of the resource transfer-out, to request to obtain the resource from the resource managing party, and the user does not need to initiate the resource acquisition operation separately. This ensures that there is always a sufficient resource in the first resource space for resource transfer-out, avoids consumption failure due to insufficient balance, facilitates the user's operation, and improves the user experience.

The schematic solution for the resource configuration apparatus in these embodiments has been described previously. It is worthwhile to note that the technical solution of the resource configuration apparatus belongs to the same concept as the technical solution of the previous resource configuration method. For details that are not described in detail in the technical solution of the resource configuration apparatus, references can be made to the description of the technical solution of the previous resource configuration method.

Corresponding to the previous embodiments of the resource configuration method shown in FIG. 2, the present specification further provides some embodiments of a resource configuration system. FIG. 5 is a schematic structural diagram illustrating a resource configuration system, according to some embodiments of the present specification. As shown in FIG. 5, the system includes a first terminal device 502, a second terminal device 504 configured with a target application, and a server 506 for a resource management service of the target application; a communication connection is established between the first terminal device 502 and the second terminal device 504, and a communication connection is established between the second terminal device 504 and the server 506.

The first terminal device 502 is configured to generate a resource transfer-out instruction, and send the resource transfer-out instruction to the second terminal device, where the resource transfer-out instruction includes a second target resource to be transferred out.

The second terminal device 504 is configured to: receive the resource transfer-out instruction, and transfer a second target resource in a first resource space to a second resource space according to the resource transfer-out instruction, where the first resource space is a resource space corresponding to the target application, and the second resource space is a resource space corresponding to the first terminal device; generate a resource acquisition request for the first resource space based on a result of the resource transfer-out, and send the resource acquisition request to the server; receive a resource allocation instruction returned by the server, where the resource allocation instruction includes a to-be-allocated first target resource; and transfer the first target resource to the first resource space of the target application according to the resource allocation instruction.

The server 506 is configured to receive the resource acquisition request, generate the resource allocation instruction that includes the first target resource based on the resource acquisition request, and send the resource allocation instruction to the second terminal device.

Optionally, the resource transfer-out instruction further includes first verification information, and the second terminal device 504 is further configured to: when receiving the resource transfer-out instruction, verify the resource transfer-out instruction based on the first verification information, and when the verification succeeds, perform the operation step of transferring a second target resource in a first resource space to a second resource space according to the resource transfer-out instruction.

Optionally, the second terminal device 504 is further configured to: generate a resource acquisition verification factor for obtaining a resource, and generate second verification information; and generate third verification information based on a result of the resource transfer-out and the resource acquisition verification factor, and add the second verification information and the third verification information to the resource acquisition request.

Optionally, the server 506 is further configured to: verify the resource acquisition request based on the third verification information included in the resource acquisition request, and when the verification succeeds, generate fourth verification information based on the second verification information and the third verification information; and add the fourth verification information to the resource allocation instruction.

Optionally, the second terminal device 504 is further configured to: verify the resource allocation instruction based on the fourth verification information included in the resource allocation instruction, and when the verification succeeds, perform the operation step of transferring the first target resource to the first resource space of the target application according to the resource allocation instruction.

Optionally, the second terminal device 504 is further configured to: when receiving the resource transfer-out instruction, determine whether a resource in the first resource space is greater than or equal to the second target resource, and if yes, perform the operation step of transferring a second target resource in a first resource space to a second resource space.

Optionally, the second terminal device 504 is further configured to: when the transfer-out of the second target resource is completed, determine whether a remaining resource in the first resource space is greater than a predetermined threshold, and if no, generate the resource acquisition request for the first resource space.

Optionally, the second terminal device 504 is further configured to: when the second target resource in the first resource space is transferred to the second resource space, generate a first resource transfer response message that includes fifth verification information; and send the first resource transfer response message to the server; and correspondingly, the server 506 is further configured to: verify the first resource transfer response message based on the fifth verification information included in the received first resource transfer response message, and when the verification succeeds, update a resource in the first resource space.

Optionally, the second terminal device 504 is further configured to: when the first target resource is transferred to the first resource space of the target application, generate a second resource transfer response message that includes sixth verification information; and send the second resource transfer response message to the server; and correspondingly, the server 506 is further configured to: verify the second resource transfer response message based on the sixth verification information included in the received second resource transfer response message, and when the verification succeeds, update a resource in the first resource space.

Optionally, the second terminal device 504 is further configured to: generate a third resource transfer response message based on the third verification information; and send the third resource transfer response message to the first terminal device; and correspondingly, the first terminal device 502 is further configured to: generate and display a result of the resource transfer-out based on the received third resource transfer response message.

Optionally, the first terminal device 502 is further configured to: send an application selection instruction that includes a device identifier of the first terminal device to the second terminal device, and receive an application response message returned by the second terminal device; and when receiving the application response message, generate the resource transfer-out instruction; and correspondingly, the second terminal device 504 is further configured to: determine a corresponding target application based on the device identifier included in the received application selection instruction, and send the application selection instruction to the target application; and obtain an application response message returned by the target application, and send the application response message to the first terminal device.

Optionally, the second terminal device 504 is further configured to: receive a virtual card application request for the target application; and when receiving virtual card application confirmation information, allocate the virtual card to the target application, and associate the virtual card with the first resource space.

Optionally, the second terminal device 504 is further configured to: receive a virtual card return request; and when receiving virtual card return confirmation information, delete data of the virtual card, and disassociate the virtual card from the first resource space.

According to the resource configuration system provided in the present specification, the first terminal device generates the resource transfer-out instruction, and sends the resource transfer-out instruction to the second terminal device; the second terminal device receives the resource transfer-out instruction, and transfers the second target resource in the first resource space to the second resource space according to the resource transfer-out instruction, and generates the resource acquisition request for the first resource space based on the result of the resource transfer-out, and sends the resource acquisition request to the server; the server receives the resource acquisition request, generates the resource allocation instruction that includes the to-be-allocated first target resource based on the resource acquisition request, and sends the resource allocation instruction to the second terminal device; the second terminal device receives the resource allocation instruction returned by the server, and transfers the first target resource to the first resource space of the target application according to the resource allocation instruction. In this case, because the resource configured for the first resource space is used for subsequent resource transfer-out, that is, the behavior of obtaining the resource and the behavior of resource transfer-out are associated with each other, if resource transfer-out occurs in the first resource space, the resource acquisition operation can be directly and automatically initiated based on the result of the resource transfer-out, to request to obtain the resource from the server, and the user does not need to initiate the resource acquisition operation separately. This ensures that there is always a sufficient resource in the first resource space for resource transfer-out, avoids consumption failure due to insufficient balance, facilitates the user's operation, and improves the user experience.

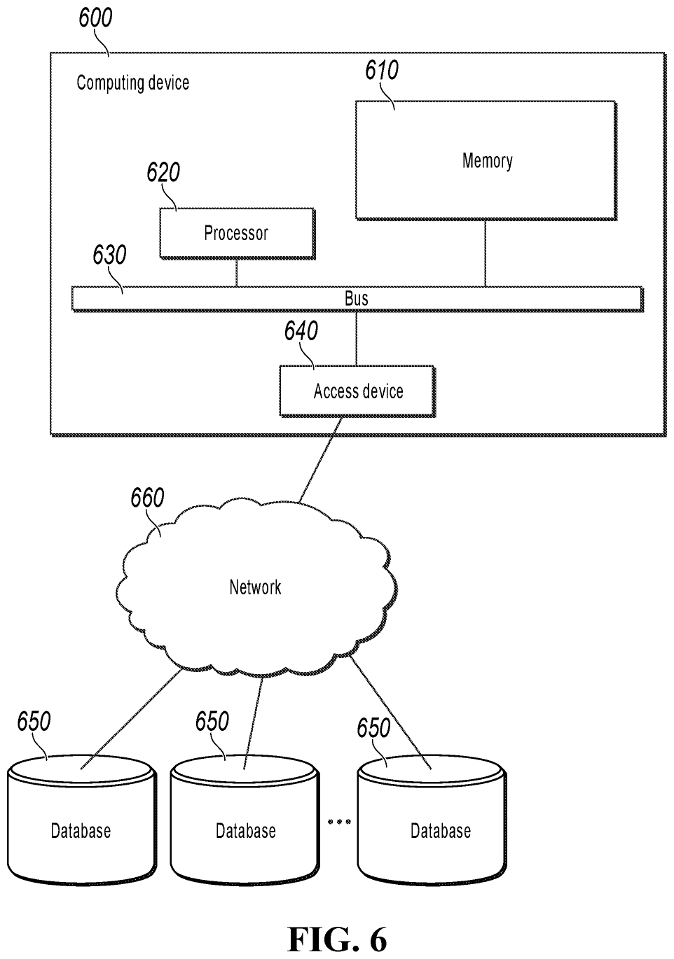

FIG. 6 is a structural block diagram illustrating a computing device 600, according to some embodiments of the present specification. Components of the computing device 600 include, but are not limited to, a memory 610 and a processor 620. The processor 620 is connected to the memory 610 through a bus 630, and a database 650 is configured to store data.

The computing device 600 further includes an access device 640, and the access device 640 enables the computing device 600 to communicate through one or more networks 660. Examples of these networks include a public switched telephone network (PSTN), a local area network (LAN), a wide area network (WAN), a personal area network (PAN), or a combination of communications networks such as the Internet. The access device 640 can include one or more of any types of wired or wireless network interfaces (for example, a network interface card (NIC)), such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, a near field communication (NFC) interface, etc.

In some embodiments of the present specification, the previous components of the computing device 600 and other components not shown in FIG. 6 can alternatively be connected to each other, for example, through a bus. It should be understood that the structural block diagram of the computing device shown in FIG. 6 is for an illustrative purpose only and is not intended to limit the scope of the present specification. A person skilled in the art can add or replace other components as needed.

The computing device 600 can be any type of stationary or mobile computing device, including a mobile computer or a mobile computing device (for example, a tablet computer, a personal digital assistant, a laptop computer, a notebook computer, a netbook, etc.), a mobile phone (for example, a smartphone), a wearable computing device (for example, a smart watch, smart glasses, etc.), or another type of mobile device, or a stationary computing device such as a desktop computer or a PC. The computing device 600 can alternatively be a mobile or stationary server.

The processor 620 is configured to execute the following computer-executable instructions: when it is detected that resource transfer-out occurs in a first resource space of a target application, generating a resource acquisition request for the first resource space; sending the resource acquisition request to a resource managing party of the target application, and receiving a resource allocation instruction returned by the resource managing party in response to the resource acquisition request, where the resource allocation instruction includes a to-be-allocated first target resource; and transferring the first target resource to the first resource space of the target application according to the resource allocation instruction.

The schematic solution for the computing device in these embodiments has been described previously. It is worthwhile to note that the technical solution of the computing device belongs to the same concept as the technical solution of the previous resource configuration method. For details that are not described in detail in the technical solution of the computing device, references can be made to the description of the technical solution of the previous resource configuration method.

Some embodiments of the present specification further provide a computer-readable storage medium, where the computer-readable storage medium stores a computer instruction, and the instruction is executed by a processor to implement the following method: when it is detected that resource transfer-out occurs in a first resource space of a target application, generating a resource acquisition request for the first resource space; sending the resource acquisition request to a resource managing party of the target application, and receiving a resource allocation instruction returned by the resource managing party in response to the resource acquisition request, where the resource allocation instruction includes a to-be-allocated first target resource; and transferring the first target resource to the first resource space of the target application according to the resource allocation instruction.

The schematic solution for the computer-readable storage medium in these embodiments has been described previously. It is worthwhile to note that the technical solution of the storage medium belongs to the same concept as the technical solution of the previous resource configuration method. For details that are not described in detail in the technical solution of the storage medium, references can be made to the description of the technical solution of the previous resource configuration method.

The specific embodiments of the present specification are described previously. Other embodiments fall within the scope of the appended claims. In some situations, the actions or steps described in the claims can be performed in an order different from the order in the embodiments and the desired results can still be achieved. In addition, the process depicted in the accompanying drawings does not necessarily require a particular execution order to achieve the desired results. In some implementations, multi-tasking and concurrent processing are feasible or may be advantageous.

The computer instruction includes computer program code, which can be in a source code form, an object code form, an executable file or a certain intermediate form, etc. The computer-readable medium can include any entity or device capable of including the computer program code, a recording medium, a USB flash drive, a removable hard disk, a magnetic disk, an optical disc, a computer memory, a read-only memory (ROM), a random access memory (RAM), an electrical carrier signal, a telecommunications signal, a software distribution medium, etc. It is worthwhile to note that the content contained in the computer-readable medium can be appropriately increased or decreased in accordance with the requirements of the legislation and patent practice in the jurisdiction, for example, in some jurisdictions, the computer-readable medium does not include electrical carrier signals and telecommunications signals in accordance with the legislation and patent practice.

It is worthwhile to note that, for a brief description, the previous method embodiments are represented as a series of actions. However, a person skilled in the art should know that the present specification is not limited to the described order of the actions, because according to the present specification, some steps can be performed in another order or simultaneously. In addition, a person skilled in the art should also know that all the embodiments described in the present specification are example embodiments, and the related actions and modules are not necessarily mandatory to the present specification.

In the previous embodiments, the descriptions of the embodiments have respective focuses. For a part that is not described in detail in some embodiments, references can be made to related descriptions in other embodiments.

The example embodiments of the present specification disclosed previously are intended only to aid in the elaboration of the present specification. The optional embodiments do not describe all the details in detail, nor do they limit the present invention to the specific implementations described. Clearly, many modifications and changes can be made according to the content of the present specification. These embodiments are selected and described in detail in the present specification in order to better explain the principles and practical applications of the present specification, so that a person skilled in the art can well understand and use the present specification. The present specification is limited only by the claims and their full scope and equivalents.

1. A computer-implemented method, comprising:
establishing, by one or more computers, a communication connection with a resource receiving device using near field communication;
detecting, by the one or more computers, occurrence of a transfer-out from a first resource space to the resource receiving device using the near field communication;
automatically triggering, by the one or more computers, generation of a first request for acquiring a resource for the first resource space of a target application based on the detection of the occurrence of the transfer-out, wherein the first resource space stores resources that are used by the target application, comprising:
generating, by the one or more computers, a verification factor including verification information of an identity of a transferor of the first resource space and second verification information that verifies an identity of a server of the target application;
sending, by the one or more computers, the first request to the server of the target application;
receiving, by the one or more computers, an allocation instruction from the server, wherein the allocation instruction is based on the first request, and wherein the allocation instruction comprises a first target resource; and
transferring, by the one or more computers, the first target resource to the first resource space of the target application according to the allocation instruction.

2. The computer-implemented method according to claim 1, further comprising:
receiving, by the one or more computers, a transfer instruction from the resource receiving device, wherein the transfer instruction comprises a second target resource that is transferred;
transferring, by the one or more computers, the second target resource from the first resource space to a second resource space according to the transfer instruction, wherein the second resource space stores second resources for the resource receiving device;
determining, by the one or more computers, that the transfer of the second target resource is completed; and
determining, by the one or more computers, that the transfer-out from the first resource space has occurred.

3. The computer-implemented method according to claim 2, wherein the transfer instruction further comprises first verification information, and
wherein the method further comprises, after receiving, by the one or more computers, the transfer instruction from the resource receiving device, and before transferring, by the one or more computers, the second target resource from the first resource space to the second resource space according to the transfer instruction, verifying, by the one or more computers, the transfer instruction based on the first verification information, and
wherein transferring, by the one or more computers, the second target resource from the first resource space to the second resource space according to the transfer instruction comprises, determining, by the one or more computers, that the verification of the transfer instruction based on the first verification information succeeds, and transferring, by the one or more computers, the second target resource from the first resource space to the second resource space according to the transfer instruction.

4. The computer-implemented method according to claim 2, further comprising, after receiving, by the one or more computers, the transfer instruction from the resource receiving device and before transferring, by the one or more computers, the second target resource from the first resource space to the second resource space according to the transfer instruction, determining, by the one or more computers, that a current resource in the first resource space is greater than or equal to the second target resource.

5. The computer-implemented method according to claim 2, comprising, after transferring, by the one or more computers, the second target resource from the first resource space to the second resource space according to the transfer instruction, determining, by the one or more computers, that a remaining resource in the first resource space is less than or equal to a threshold and generating, by the one or more computers, the first request for acquiring the resource for the first resource space automatically.

6. The computer-implemented method according to claim 1, wherein automatically triggering, by the one or more computers, generation of the first request for acquiring the resource for the first resource space of the target application comprises:
generating, by the one or more computers, a verification factor including verification information of an identity of a transferor using the first resource space and second verification information that verifies an identity of the server;
generating, by the one or more computers, third verification information based on the verification factor; and
generating, by the one or more computers, the first request for acquiring the resource for the first resource space of the target application based on the second verification information and the third verification information.

7. The computer-implemented method according to claim 6, wherein the allocation instruction comprises fourth verification information, and transferring, by the one or more computers, the first target resource to the first resource space of the target application according to the allocation instruction comprises:
verifying, by the one or more computers, the allocation instruction based on the fourth verification information;
determining, by the one or more computers, that the verification of the allocation instruction based on the fourth verification information succeeds; and
transferring, by the one or more computers, the first target resource to the first resource space of the target application according to the allocation instruction.

8. The computer-implemented method according to claim 2, further comprising, after transferring, by the one or more computers, the second target resource from the first resource space to the second resource space:
generating, by the one or more computers, a first response that comprises fifth verification information; and
sending, by the one or more computers, the first response to the server.

9. The computer-implemented method according to claim 8, further comprising, after transferring, by the one or more computers, the first target resource to the first resource space of the target application according to the allocation instruction:
generating, by the one or more computers, a second response that comprises sixth verification information; and
sending, by the one or more computers, the second response to the server.

10. The computer-implemented method according to claim 6, further comprising, after generating, by the one or more computers, the third verification information based on the transfer-out and the verification factor:
generating, by the one or more computers, a third response based on the third verification information; and
sending, by the one or more computers, the third response to the resource receiving device.

11. The computer-implemented method according to claim 1, further comprising:
receiving, by the one or more computers, a second request for applying for a virtual card of the target application; and
creating, by the one or more computers, the virtual card for the target application, and associating the virtual card with the first resource space after receiving confirmation of the target application of the virtual card.

12. The computer-implemented method according to claim 11, further comprising:
receiving, by the one or more computers, a third request for returning the virtual card of the target application; and
deleting, by the one or more computers, data of the virtual card, and disassociating the virtual card from the first resource space after receiving the confirmation of the return of the virtual card.

13. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
establishing, by the one or more computers, a communication connection with a resource receiving device using near field communication;
detecting, by the one or more computers, occurrence of a transfer-out from a first resource space to the resource receiving device using the near field communication;
automatically triggering, by the one or more computers, generation of a first request for acquiring a resource for the first resource space of a target application based on the detection of the occurrence of the transfer-out, wherein the first resource space stores resources that are used by the target application, comprising:
generating, by the one or more computers, a verification factor including verification information of an identity of a transferor of the first resource space and second verification information that verifies an identity of a server of the target application;
sending, by the one or more computers, the first request to the server of the target application;
receiving, by the one or more computers, an allocation instruction from the server, wherein the allocation instruction is based on the first request, and wherein the allocation instruction comprises a first target resource; and
transferring, by the one or more computers, the first target resource to the first resource space of the target application according to the allocation instruction.

14. The computer-implemented system according to claim 13, further comprising
receiving, by the one or more computers, a transfer instruction from the resource receiving device, wherein the transfer instruction comprises a second target resource that is transferred;
transferring, by the one or more computers, the second target resource from the first resource space to a second resource space according to the transfer instruction, wherein the second resource space stores second resources for the resource receiving device;
determining, by the one or more computers, that the transfer of the second target resource is completed; and
determining, by the one or more computers, that the transfer-out from the first resource space has occurred.

15. The computer-implemented system according to claim 14, wherein the transfer instruction further comprises first verification information, and
wherein the one or more operations comprise, after receiving the transfer instruction from the resource receiving device, and before transferring the second target resource from the first resource space to the second resource space according to the transfer instruction, verifying the transfer instruction based on the first verification information, and
wherein transferring the second target resource from the first resource space to the second resource space according to the transfer instruction comprises:
determining that the verification of the transfer instruction based on the first verification information succeeds; and
transferring the second target resource from the first resource space to the second resource space according to the transfer instruction.

16. The computer-implemented system according to claim 14, further comprising, after receiving, by the one or more computers, the transfer instruction from the resource receiving device, and before transferring, by the one or more computers, the second target resource from the first resource space to the second resource space according to the transfer instruction, determining, by the one or more computers, that a current resource in the first resource space is greater than or equal to the second target resource.

17. The computer-implemented system according to claim 14, further comprising, after transferring the second target resource from the first resource space to the second resource space according to the transfer instruction, determining that a remaining resource in the first resource space is less than or equal to a threshold; and generating the first request for acquiring the resource for the first resource space automatically.

18. The computer-implemented system according to claim 13, wherein automatically triggering, by the one or more computers, generation of the first request for acquiring the resource for the first resource space of the target application comprises:
generating, by the one or more computers, a verification factor including verification information of an identity of a transferor using the first resource space and second verification information that verifies an identity of the server;
generating, by the one or more computers, third verification information based on the verification factor; and
generating, by the one or more computers, the first request for acquiring the resource for the first resource space of the target application based on the second verification information and the third verification information.

19. The computer-implemented system according to claim 18, wherein the allocation instruction comprises fourth verification information, and transferring the first target resource to the first resource space of the target application according to the allocation instruction comprises:
verifying the allocation instruction based on the fourth verification information;
determining that the verification of the allocation instruction based on the fourth verification information succeeds; and
transferring the first target resource to the first resource space of the target application according to the allocation instruction.

20. A non-transitory, computer-readable medium storing one or more instructions executable by a computer system to perform operations comprising:
establishing, by one or more computers, a communication connection with a resource receiving device using near field communication;
detecting, by the one or more computers, occurrence of a transfer-out from a first resource space to the resource receiving device using the near field communication;
automatically triggering, by the one or more computers, generation of a first request for acquiring a resource for the first resource space of a target application based on the detection of the occurrence of the transfer-out, wherein the first resource space stores resources that are used by the target application, comprising:
generating, by the one or more computers, a verification factor including verification information of an identity of a transferor of the first resource space and second verification information that verifies an identity of a server of the target application;
sending, by the one or more computers, the first request to the server of the target application;
receiving, by the one or more computers, an allocation instruction from the server, wherein the allocation instruction is based on the first request, and wherein the allocation instruction comprises a first target resource; and
transferring, by the one or more computers, the first target resource to the first resource space of the target application according to the allocation instruction.
